(19) United States
(12) Patent Application Publication
(10) Pub. No.: US 2015/0052082 A1
(43) Pub. Date: Feb. 19, 2015

(54) SHAPED FOOD CONTAINER

(71) Applicant: William Todd Pordy, New York, NY (US)

(72) Inventor: William Todd Pordy, New York, NY (US)

(21) Appl. No.: 14/460,772

(22) Filed: Aug. 15, 2014

Related U.S. Application Data
(60) Provisional application No. 61/959,118, filed on Aug. 15, 2013.

(51) Int. Cl. B65D 81/38; G06Q 90/00

(52) U.S. Cl. CPC B65D 81/38; G06Q 90/00
USPC 705/500; 220/669; 220/592.2

(57) ABSTRACT

The present invention is a food container, or vessel, having a body shaped in the form of a recognizable feature of a subject, a method of using said food container for promoting a subject having a recognizable feature, a method of using said food container to promote the sale of the food stored therein, and a method of fabricating a food container of the type disclosed herein.

### PRIORITY

Priority is claimed to Provisional Patent Application Ser. No. 61/959,118, filed Aug. 15, 2013 by William Todd Pordy and entitled “Ice Cream Cones Enhanced, Extended, Expanded Shapes, Often with Names, Texts, Colors.”

### FIELD OF THE INVENTION

The present invention relates to food containers, or vessels, particularly shaped in the form of a recognizable feature of a subject. This invention also relates to a method for promoting a subject by creating and distributing a food container shaped in the form of a recognizable feature of the subject. This invention also relates to a method for promoting a food product by distributing it in a food container shaped in the form of a recognizable feature of a subject. The food container disclosed herein also incorporates design features to facilitate the addition of food to the container and eating from the container. The present invention further relates to a method of manufacturing a food container shaped in the form of a recognizable feature of a subject.

### BACKGROUND OF THE INVENTION

Food containers of various materials having a variety of sizes and shapes are well known in the art. The materials used to form such containers are largely dictated by the food product being packaged, as are the size and shape of the container. It is also well known to print various information on the exterior of a container to identify the source of the product, such as the name and/or trademark of the manufacturer, artwork depicting the food product in the container, or the manner of use thereof and information about the food product itself, such as the ingredients, the caloric content, or the flavor or color enhancements in the food product.

Food containers tend to have common geometric shapes, such as cylindrical, cone or rectangular, and are generally not considered to be a vehicle for promoting anything, other than the food product itself, which is typically accomplished through the printed matter appearing on the exterior surface of the container.

Some products are sold in containers made of edible materials. For example, frozen confections such as ice cream, fresh or frozen yogurt, sorbet, frozen custard, pudding and the like are often sold in edible cones formed in conical or truncated cylindrical shapes, having smooth, or waffle surfaces. Those cones are made using conventional processes, such as molding and wrapping. Although cones of other shapes are also known, those shapes are provided for decorative or aesthetic purposes only and have no particular significance or function other than to look attractive while acting as an edible frozen food product holder.

It is estimated that on average it takes from eleven to fifteen minutes to consume a cone with a double scoop of ice cream or similar food product. During that time period, the cone is for the most part visible to the person consuming the product as well as others within the vicinity. And holding a shaped object in a person's hand further conveys and reminds the holder of the subject. This presents a great opportunity to use the cone as a medium for promoting a subject that is currently not being taken advantage of By the same token, an opportunity to encourage the sale of the food product in the cone is also being lost. It is imagined that the food container disclosed herein could be used as part of promotional and/or marketing efforts, such as discount and customer loyalty programs.

Therefore one objective of the invention is to provide a food having a shape in the form of a recognizable feature of a subject. In one embodiment the food container is suitable for holding frozen confections. In other embodiments the food container/vessel is designed to accept warm or even hot food products such as porridge, pudding, gelatin, and even liquids.

Another objective of the present invention is to provide a method of promoting a subject through the use of a food container having a shape associated with a recognizable feature of the subject.

Another objective of the present invention is to provide a method of promoting a food product by distributing it in a food container that has a shape associated with a recognizable feature of a subject.

It is another object of the present invention to provide a method of fabricating a food container utilizing a molding process, or 3-D layering techniques.

### SUMMARY OF THE INVENTION

The present invention is a food container, or vessel, having a body shaped in the form of a recognizable feature of a subject, a method of using said food container for promoting a subject having a recognizable feature, and a method of fabricating a food container of the type disclosed herein.

More specifically, the food container of the present invention is comprised of a body shaped in the form of a recognizable feature of a subject. The particular size, shape, and features of the body may vary depending upon the shape of the recognizable feature and the intended food product to be placed in the food container. The food container may be made of either an edible or inedible material, or a combination of both. The material may be disposable or reusable. The food container may also include sound producing and sound recording components. The food container can be designed to include other features such as being stackable and enhanced features to facilitate better gripping.

For example, the food container may be used for holding and serving frozen confections, similar to the function of a traditional ice cream cone. In such an embodiment, it is envisioned that the food container disclosed herein will provide significant advantages over the current technology. For example, in this embodiment, if the food container is made of a rigid, impermeable material it will provide for a better grip and can be designed to minimize or eliminate leakage when the ice cream or other frozen confection melts.

The method of promoting a subject or a food product using a food container comprised of a body shaped in the form of a recognizable feature of the subject to be promoted is generally comprised of the following steps: selecting a food product; selecting a subject; selecting a recognizable feature of the subject; designing and creating a food container for a food product, wherein said food container is comprised of a body shaped in the form of the selected recognizable feature of the subject. The food container can be distributed with or without the food in it. A bag can be presented or sold with the vessel to provide a convenient means of carrying the empty, dirty vessel until it is possible to clean the vessel. The bag may include information and/or images of the selected subject thereon.

By serving food product in the food container disclosed herein, the subject is continually being conveyed and reinforced to user of the food container both visually and tactilely. The body of the food container may have an upper and lower section, which are either permanently or removably attached. The upper section may have a depression which extends inwards from the outer perimeter thereof. The depression can have a hole in it to allow for melting food product to drain into the interior of the body, if the body is hollow. If the upper and lower sections are removably connected, the individual sections can be stacked upon each other.

### DESCRIPTION OF THE DRAWINGS

FIG. 1 is a perspective view of one embodiment of the food container disclosed herein.

FIG. 2 is a cross-sectional view of the food container disclosed herein, including a layer of thermal insulation.

FIG. 3 is a cross-sectional view of a second embodiment of the food container disclosed herein, including a moat.

FIG. 4 is a cross-sectional view of the food container disclosed herein, where the moat has perforations made therein, and such cross-section cuts through perforations on opposite sides of the container.

FIG. 5 is a cross-sectional view of a third embodiment of the food container disclosed herein, where the upper section and lower section are removably connected.

FIG. 6 is a top view of the food container disclosed herein, wherein the depression includes a perforation made therein.

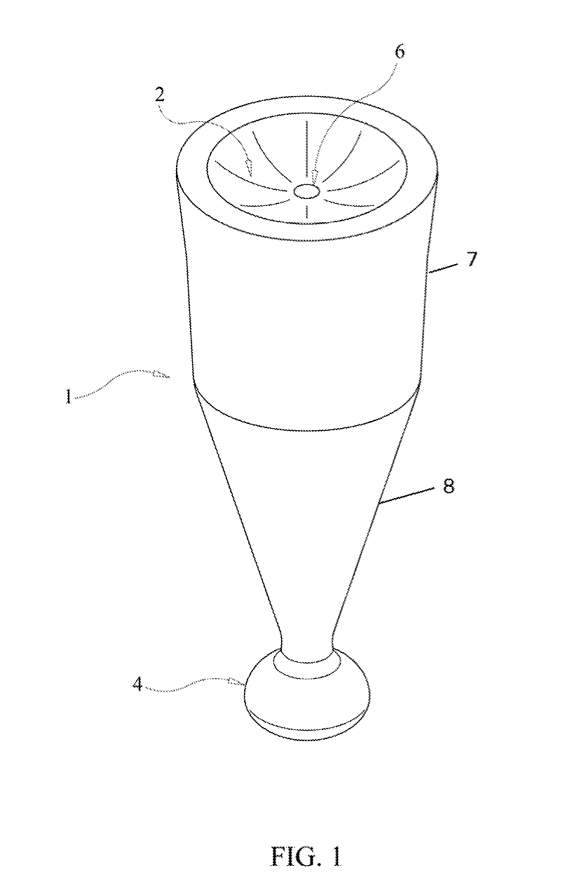

### DETAILED DESCRIPTION

The present invention is a food container for holding a food product having a body (1) shaped in the form of a recognizable feature of a selected subject, as well as a method of promoting the selected subject using the aforementioned food container, a method of promoting a food product using the aforementioned food container, and a method of forming said food container.

As used throughout this patent, the term “subject” is to be construed broadly to include, without limitation, any individual, place or thing, whether tangible or intangible, having a feature which is readily recognizable by the general public or by a segment of the public. For example, an individual subject may include a celebrity, a politician, a character from a literary work such as a book, movie, cartoon, a historical figure, a member of a sports team, a holiday (national or religious), or a member of a music group. A subject place may include a street, town, village, city, state, county, geographic area or location, such as New York City, Broadway, a national park or a sports arena or team. A subject thing may include an institution, organization, building, monument, activity, religion, holiday, vocation, avocation, art object, product, brand, service, mascot, sports event, restaurant, a logo or trademark, an event, or political party. Possible categories and examples in those categories are as follows:

GLOBAL—monuments/landmarks, mascots:
Rome (classic orders or columns), France (Eiffel Tower) Spain (Sagrada Familia), UK (Big Ben),
US (Capital DC, world trade center), Mesoamerica (Mayan Temple
India: Taj Mahal
   LOCAL (four categories):
1) areas: South Beach (Miami), Southwest cactus (three different branches, separate scoops), Big Apple (sold with ice cream in front of Apple Stores)
2) high points: Cone-y island (Parachute), High Line, Radio City Music Hall (Rockettes' legs), World Trade Center (NYC), TransAm (San Fran), Notre Dame—13 MM
3) Theme Parks: Disneyland, Universal Studios, Knott' Berry Farm, Six Flags, Magic Kingdom

4) Architecture: support/connected, devoted, interest for historical/sustainable

VOCATIONS: army & medicine (caduceus), legal/court+government (blind justice), financiers ($ shape), musicians (based on music notes); music instrument shape
AVOCATIONS: sports (hockey (Stanley Cup winners*), baseball, basketball, golf (2), football, Olympic torch), rockets, guns (bullets), museums and art, culture: plays, opera, movies
SOCIAL DEMOGRAPHICS: shoes (women), LGBT (Kokeshi)—shaped as a phallus or a breast

### RELIGIONS:

Judaism: shofar. Christianity: cross
   HOLIDAYS (three categories):
1) National: Thanksgiving (cornucopia), Happy New Year (party hats), July 4 (Statue of Liberty)
2) Religious holidays: Christmas tree, dradle
3) Personal: birthday, bar/bat mitzvah, confirmation, sweet sixteen, wedding, divorce: ‘I'm Free!” and picture
   EDUCATIONAL INSTITUTIONS (Universities): graduation, alumni, students, support (NYU torch*, Columbia Crown)
   SPORTS AND TEAMS: baseball, basketball, football (Super Bowl), hockey (Stanley Cup), golf

The phrase “recognizable feature” is used herein to include, without limitation, any physical attribute of a subject which is readily recognized as being associated with the subject. For example the shape of a building, such as the Empire State building, the Flat Iron building or Grand Central Terminal are readily recognized as being associated with New York City. The shape of monuments such as the Lincoln Memorial and Washington Monument are associated with Washington D.C. The shape of a column is associated with ancient Greece and Rome. The shape of the Statue of Liberty is associated with America. The shape of the Eiffel Tower is associated with Paris. The shape of the Liberty Bell is associated with Philadelphia.

With regard to products the shape of a classic Coca-Cola bottle is associated with the drink. The shape of a football is associated with the National Football League. The shape of a tennis racket may be associated with Wimbledon. The shape of a baseball bat may be associated with any baseball team. The shape of a golf club may be associated with a golf tournament. The shape of a bullet/cartridge may be associated with the National Rifle Association. The shape of a religious symbol such as a Christmas tree or cross is associated with Christianity and Christmas season. The shape of a six pointed star or ram's horn is associated with Judaism. The shape of the Olympic Torch is associated with the Olympics. The shape of a crown is associated with Columbia University. The shape of a donkey is associated with the Democratic Party. The shape of a Caduceus is associated with a medical center.

The food container of the present invention may be made of an edible or non-edible material, or a combination of the two. Examples of edible materials may include but are not limited to waffles, wafers, crackers and other pastries. Examples of non-edible materials include but are not limited to plastics, nylon, cardboard, metals, and ceramics. The material selected may depend upon the food to be placed in the container, the intended duration for which the food is to be stored in the container, and the subject sought to be promoted.

The food container may also be comprised in whole or in part of a material capable of glowing in the dark. In another embodiment the food container may be comprised in whole or in part of a material which changes color with changing temperature. In such an embodiment, the food container will change color as the temperature of the food product contained therein changes (i.e. melts or cools).

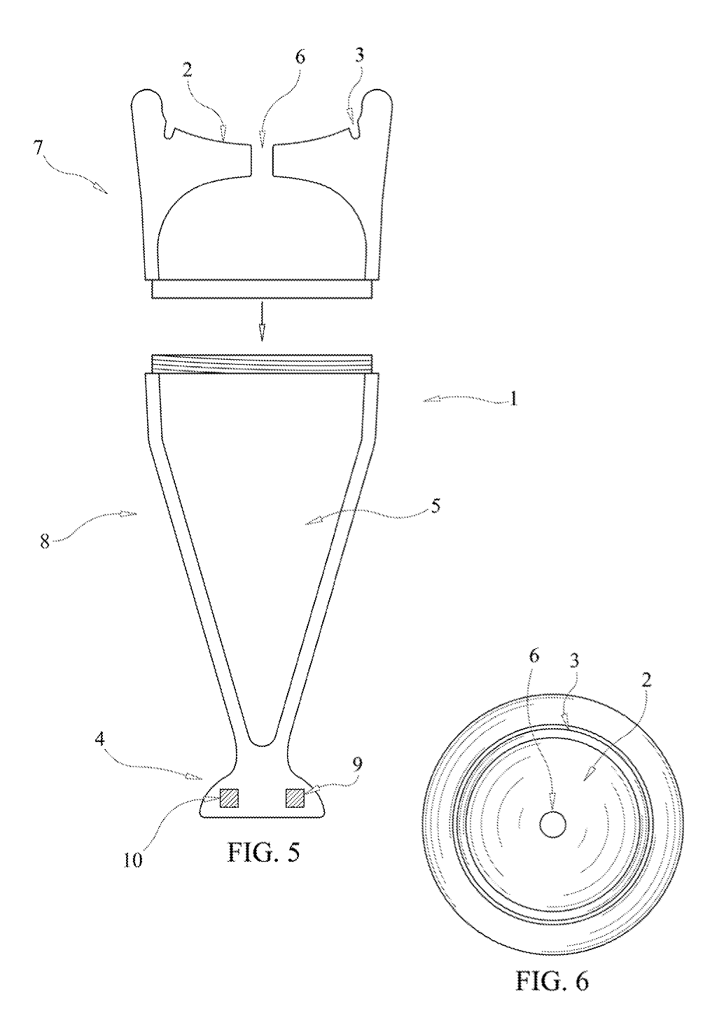

In an additional embodiment (see FIG. 5) the food container may be equipped with audio-visual components, such as sound producing components (9), sound recording components (10) and video recording and/or video display components. For example, sound producing components (9) could include but are not limited to a silicon chip, a battery, a switch, and a speaker. It is envisioned that users will be able allowed to create and play customized audio and/or video messages.

In addition to being shaped in the form of a recognizable feature of a subject, the body (1) of the food container may take any form suitable for holding food products. As such, the shape, composition, size, and features of the body (1) may change depending upon the food product it is intended to hold and the recognizable feature sought to be portrayed. For example, the body (1) of the food container may be comprised of one or more sidewalls, a base (4) enclosing the bottom of the body, and an open top. Preferably the food container is designed with dimensions and a shape such that it may be held by the user with only one hand. The food container may be designed such that it may be firmly gripped by the user, with the user's hand wrapped around at least a portion of the food container, while eating food product from it.

The food container shown in the figures has a body (1) in the shape of a baseball bat. But as stated previously, the shape can be any recognizable feature of the selected subject.

The food container can be designed specifically for holding frozen confections such as ice cream, fresh or frozen yogurt, sorbet, frozen custard, pudding, and the like, essentially serving the function of an ice cream cone. But the food container can also be used for temperate or even hot food products, such as porridge for example.

The body (1) has an upper section (7) and a lower section (8). The upper section (7) has a depression (2) extending inward from the outer perimeter in the top area thereof. In a specific embodiment the depression (2) is circular, has a concave shape, and is sized to accommodate a standard serving size of ice cream, approximately four to six ounces or more. If the food container is intended to hold other food products, or a different serving size, the size and shape of the depression (2) can be varied as warranted. The upper section (7) may also include a moat (3). The moat (3) is an indentation that follows the shape of the outer perimeter of the upper section. The purpose of the moat (3) is to capture runoff should the frozen confection melt. The body may also have a base (4) which is flat and of sufficient surface area to permit the food container to stand independently on a surface such as a table or counter top.

The body (1) may be solid or have a hollow interior (5). The depression (2) and the moat (3) may have one or more perforations (6) made therein, allowing any melted food product to drain into the hollow interior (5) of the body (1). The perforations (6) are typically circular in shape with a diameter of approximately 0.5 centimeters (0.2 inches). The body (1) may be constructed of a non-permeable material to prevent leaking of the melted food product from the body (1). Furthermore, the perforations (6) serve to allow for the passage of water and cleaning solutions to easily clean the food container.

In an alternative embodiment, shown in FIG. 5, the upper section (7) and lower section (8) are removably connected using a fastening means that allows for easy decoupling, such as threading. The upper section (7) may also be comprised of a material such as rubber which is sized to securely fit onto the lower section (8), and vice versa. Separation of the upper and lower sections allows easy access for thorough cleaning and easier storage. When the upper section (7) and the lower section (8) are removable, it allows for the individual components to be easily stacked for storage and shipping.

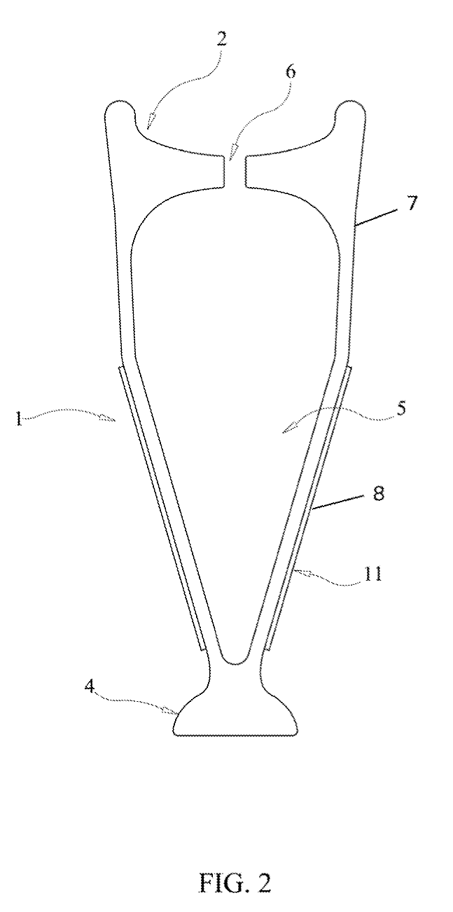

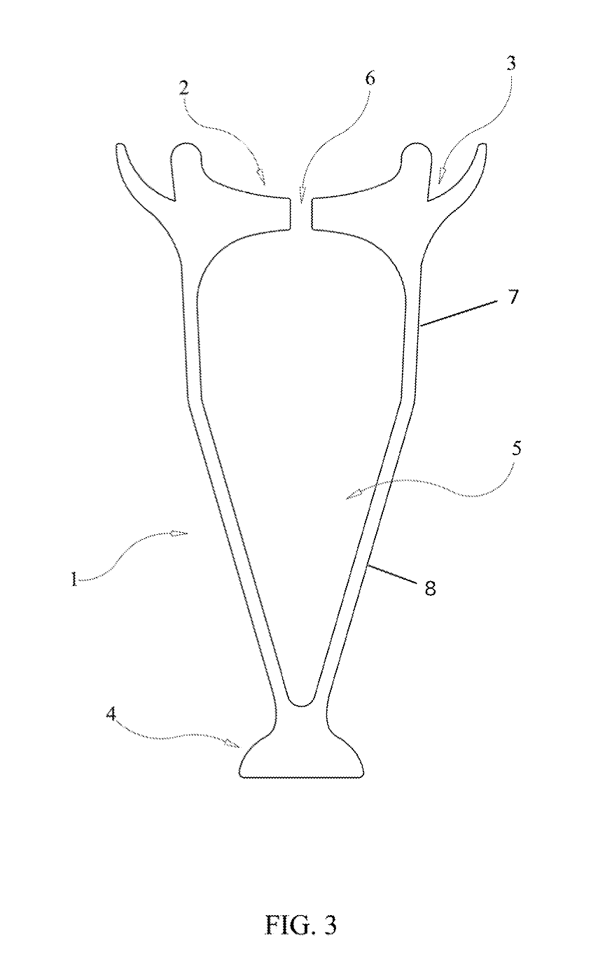

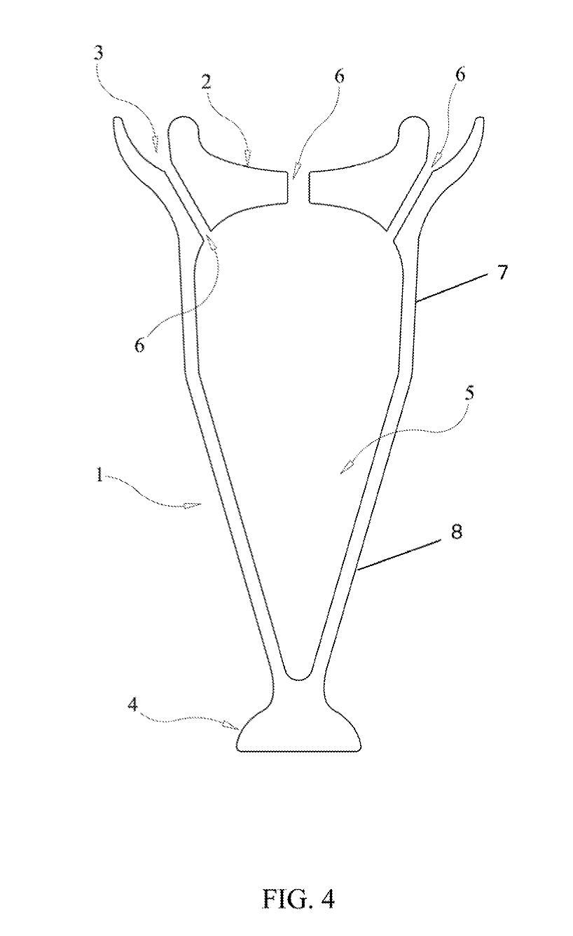

As shown in FIG. 2, the body (1) of the food container may also incorporate a layer of thermal insulation (11) to delay temperature changes in the food product contained therein. The insulation may be incorporated on the outer surface as shown or interior to the outer surface and may be included on all or a portion of the food container.

Food containers of the typed disclosed herein may be displayed in a custom display holder. The display holder has slots specifically sized and shaped to accommodate unique shape of the food containers disclosed herein. The holders may include information or images about the subject associated with the recognizable feature.

The food container may display information on its exterior surface related to the subject chosen. This information can be presented in the form of text, coloring, images, symbols, videos, or other forms.

The present invention further includes a method of promoting a subject having a recognizable feature through the distribution of a food product in a food container having a body (1) shaped in the form of a recognizable feature of the subject.

The method of promoting a subject is comprised of: selecting a subject to be promoted; selecting a food product; selecting a recognizable feature of the subject; designing and creating a food container having a body (1) that is shaped in the form of the recognizable feature of the subject; placing the food product in the food container; and, distributing the food product in the food container.

The aforementioned food container may take the form of any of the embodiments described above or shown in the Figures In another embodiment sleeves which are designed to be placed over an existing container are created with recognizable images of the subject. The sleeve may be 3-dimensional to replicate the shape of a recognizable feature of the subject.

The term “promoting” as used herein is to be broadly construed to mean, without limitation, advertising, recognizing, demonstrating patronage for, showing interest in, advocating for, subsidizing, subscribing to, using, upholding, bolstering, cultivating, encouraging, announcing, praising, inducing the purchase of, offering for sale or encouraging the sale of a subject.

The step of distributing the food product may include distributing the food product at a location proximate to the subject; distributing the food product at a time associated with the subject; offering the food product for sale in the food container; distributing the food product in the food container free of charge. The food container may also be distributed with a bag to provide a convenient means of carrying the food container. The bag may include information and/or images of the selected subject thereon.

For example, suppose that there is a campaign to promote tourism in Washington D.C. (the subject). One could select the shape of the Washington Monument as being a recognizable feature associated with Washington D.C. Then, a suitable food product is selected—in this case, presume that ice cream is the selected food product. A food container with a body (1) in the shape of the Washington Monument is then procured. Ice cream vendors in and around Washington D.C., particularly in the vicinity of the Washington Monument, could be provided with food containers having a body (1) in the shape of the Washington monument. The vendors place ice cream in the food container and distribute them to customers and/or tourists. The vendor may offer the ice cream in the food container or may provide the food container with the ice cream free of charge as a promotional offer. The vendor may also offer a reduced price for the food product if the vessel is reused.

The present invention further includes a method of promoting the sale of a food product in a food container having a body (1) shaped in the form of a recognizable feature of a subject. The method of promoting a the sale of a food product is comprised of selecting a food product; selecting a subject; selecting a recognizable feature of the subject; designing and creating a food container for the food product having a body shaped in the form of a recognizable feature of the subject; placing the food product in the food container; and distributing the selected food product in the food container having a body shaped in the form of the recognizable feature of the subject. The aforementioned food container may take the form of any of the embodiments described above or shown in the Figures.

An example of promoting the sale of a food product according to the method disclosed would include selecting a suitable food product, such as a fruit cocktail. Then, a subject is selected, for example New York City. Then a recognizable feature of the subject (New York City) is selected, which in this example is the Statue of Liberty. A food container having a body (1) in the shape of the Statue of Liberty is then designed and created. Of course, the body (1) of the food container should also be in a shape and made of a material suitable for accommodating the selected food product, which in this example is fruit cocktail. The food container and food product are then distributed. For example, the distribution may be in New York City, promoting tourism in the city.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. A food container comprised of:
a body having an upper section and a lower section, wherein the body is formed in a shape of a recognizable feature of a subject;
the upper section having an outer perimeter, wherein a depression in only the upper section extends inward from the outer perimeter wherein the body is designed to be held in one hand.

2. The food container of claim 1 wherein the body has a hollow interior and the depression has one or more perforations made therein.

3. The food container of claim 2 wherein the body is further comprised of a base, wherein the base is flat and of sufficient surface area to permit the food container to stand independently on a flat surface.

4. The food container of claim 1 wherein the body is further comprised of a layer of thermal insulation.

5. The food container of claim 1 wherein the body is further comprised of one or more audio-visual components.

6. The food container of claim 1 wherein the body is further comprised of a base, wherein the base is flat and of sufficient surface area to permit the food container to stand independently on a flat surface.

7. The food container of claim 1 wherein the body is further comprised of a moat.

8. The food container of claim 7 wherein the body has a hollow interior and one or more perforations in the depression and the moat.

9. The food container of claim 8 wherein the body is further comprised of a base, wherein the base is flat and of sufficient surface area to permit the food container to stand independently on a flat surface.

10. The food container of claim 1 wherein the upper section and the lower section are removably connected.

11. The food container of claim 10 wherein the body is further comprised of a layer of thermal insulation.

12. The food container of claim 10 wherein the upper section is a further comprised of a moat.

13. The food container of claim 10 wherein the body has a hollow interior and one or more perforations in the depression and moat.

14. The food container of claim 10 wherein the body is further comprised of an exterior surface on which information is displayed.

15. The food container of claim 10 further comprised of one or more audio-visual components.

16. A display holder for the food container of claim 1, wherein the display holder has slots made therein to accommodate the body of the food container.

17. A method of promoting a subject comprised of:
selecting a subject to be promoted;
selecting a food product;
selecting a recognizable feature of the subject; and,
designing and creating a food container for the selected food product wherein the food container is comprised of a body having an upper section and a lower section, the body is formed in a shape of a recognizable feature of a subject, the upper section has an outer perimeter, wherein a depression in only the upper section extends inward from the outer perimeter, and wherein the body is designed to be held in one hand.

18. The method of promoting a subject of claim 17 further comprised of:
placing the selected food product in the food container; and,
distributing the food product in the food container.

19. The method of promoting a subject of claim 18 further comprised of:
selecting a bag with dimensions to accommodate the selected food container;
distributing the bag with the food product.

20. A method of promoting the sale of a food product comprised of:
selecting a food product to be promoted;
selecting a subject;
selecting a recognizable feature of the subject;
designing and creating a food container for the selected food product wherein the food container is comprised of a body having an upper section and a lower section, the body is formed in a shape of a recognizable feature of a subject, the upper section has an outer perimeter, wherein a depression in only the upper section extends inward from the outer perimeter, and wherein the body is designed to be held in one hand;
placing the selected food product in the food container; and,
distributing the selected food product in the food container.
